(19) United States
(12) Patent Application Publication
(10) Pub. No.: US 2002/0152866 A1
(43) Pub. Date: Oct. 24, 2002

(54) Blade holder with schock absorber for a device for longitudinally cutting a material strip

(76) Inventors: Willi Bilstein, Overath (DE); Ingo Picker, Much (DE)

Correspondence Address: VENABLE, BAETJER, HOWARD AND CIVILETTI, LLP, P.O. BOX 34385, WASHINGTON, DC, 20043-9998, US

(21) Appl. No.: 10/129,082

(22) PCT Filed: Jan. 12, 2001
(86) PCT No.: PCT/EP01/00318

(30) Foreign Application Priority Data
Sep. 2, 2000 (DE) 200 15 168.1

(51) Int. Cl. B26D 1/00; B26D 7/06

(52) U.S. Cl. 83/433; 83/698.51; 83/663; 83/698.31; 83/508.2

(57) ABSTRACT

The invention relates to a blade holder for a device for dividing a material web (10) in longitudinal direction, said blade holder comprising a basic body (2) that can be secured on a cutter bar (M) of the device. The blade holder further comprises a blade carrier (3; 23), which can be moved relative to the basic body (2) and on which a circular blade (8; 22) is positioned rotating and which is connected to an adjustment drive (4; 24) for moving the circular blade (8; 22) from the idle position to an operating position where it is pushed against an associated rotating counter blade (9; 28) of the device. In addition, the blade holder is provided with an impact absorber (11) that is effective between the adjustment drive (4; 24) and the circular blade (8; 22) and has a high compliance to a force effective in press-on direction and a low compliance to a force effective counter to the press-on direction.

Devices used for dividing material webs in longitudinal direction are provided with a cutter bar, which is arranged crosswise to the material web passing through and comprises several side-by-side arranged blade holders. The distance between the blade holders, relative to each other, is predetermined in each case by the “cutting program,” meaning by the correspondingly narrower material strips to be cut from the wide material web passing through. The material is divided in longitudinal direction either with a so-called crush cut using a circular crush blade that is pressed against a roller functioning as counter blade, or with a so-called shearing cut, for which the cutting edge of a circular blade fits on the side against the cutting edge of a rotating counter blade with a certain overlap. In the following, the terms “circular blade” and “counter blade” are used uniformly for both dividing methods.

For both application cases, the blade holder is provided with a basic body that can be connected to the cutter bar and a blade carrier that can be moved relative thereto, on which the circular blade is positioned such that it can rotate. By means of a generally pneumatic adjustment drive, the circular blade is pressed in the operating position against the associated counter blade to generate the required cutting force.

The pneumatic adjustment drive formed with a piston-cylinder system simultaneously functions as a pressure spring, which presses the circular blade with a constant force, but also compliant to a degree, against the counter blade. Thus, true running irregularities such as a “height jump” during a crush blade cut or a “side jump” for a shearing cut are compensated since the blade is readjusted with the adjustment drive and direct contact with the counter blade is maintained. A “height jump” of this type can occur with a crush blade cut even with an exact blade geometry if the material webs to be divided have thickened material sections, which may be unintended or intended, depending on the material structure. Differing material strengths can also become noticeable in the same way as the true running accuracy.

However, with high movement speeds of the material web and correspondingly high running speeds for the circular blade and the counter blade, the contact between circular blade and counter blade is broken at times during “true running” irregularities. Poor cutting quality is the result, for example an insufficient division of the material during the crush cut that may not be continuous in longitudinal direction or insufficient cutting edge accuracy during the shearing cut.

It is the object of the invention to create a blade holder, which avoids these disadvantages.

This object is solved according to the invention with a blade holder for a device for longitudinally dividing a material web, which comprises a basic body that can be attached to a cutter bar for the device, a blade carrier that is movable relative to the basic body, on which a circular blade is mounted so as to rotate and which is connected to an adjustment drive for moving the circular blade from an idle position to an operating position on an associated rotating counter blade of the device, as well as with an impact absorber that is effective between the adjustment drive and the circular blade and has a high compliance for the force effective in press-on direction and a low compliance for the force effective counter to the press-on direction. In particular with high through speeds, for which true running irregularities have a jolting effect on the circular blade, an impact absorber of this type will prevent the circular blade from lifting off the counter blade or from “dancing” on the counter blade during the appearance of resonance. The circular blade is readjusted in its operating position in press-on direction on the counter blade as a result of the adjustment force exerted by the adjustment drive. However, as soon as a force counter to the press-on direction acts upon the circular blade as a result of the true running irregularity, the circular blade can ease up, but must overcome a higher resistance.

One advantageous embodiment of the invention is provided with an impact absorber comprising a cylinder and a piston body, which can be moved relative to the cylinder and delimits a pressure chamber inside the cylinder. A throttle and a return valve are assigned to the pressure chamber, wherein the return valve opens up during a circular blade movement in press-on direction. For this embodiment, the cylinder is attached, for example, to the basic body while the piston body is assigned to the blade carrier. Thus, during a movement in press-on direction that is effected via the adjustment drive, the medium contained in the pressure chamber, for example air or a liquid, is pushed from the pressure chamber counter to the only slight opening resistance of the return valve. In the process, the circular blade is pushed with its predetermined contact pressure force against the counter blade.

However, if the circular blade is acted upon in the opposite direction, for example during a height jump caused by a material thickening or the like, the return valve is closed. Thus, the medium can flow back into the pressure chamber only by overcoming the flow resistance in the throttle and only with a delay. In this way, the circular blade can be pushed back with the aid of the counter blade and can avoid the height jump without breaking the contact to the counter blade. The force exerted by the adjustment drive is supported by the additional force effect of overcoming the throttle resistance. As soon as the force effective in counter direction slows, the circular blade can be readjusted quickly as a result of the adjustment force.

The throttle of one embodiment of the invention is formed by the gap between piston body and cylinder wall. A seal between cylinder wall and piston body can be omitted with this embodiment, so that the free floating of the piston inside the cylinder, which is necessary for a trouble-free and easy movement, simultaneously has a throttle effect. If the existing gap is not sufficient, the cylinder wall and/or the circumferential surface area of the piston can be provided with a correspondingly dimensioned groove, which makes it possible to specify a defined throttle cross section. In addition, the length of the cylinder wall covered by the piston body, but also the groove length, for example in the form of a spiral groove on the circumferential surface of the piston, can be utilized for specifying a defined throttle effect.

The throttle of another embodiment of the invention has an adjustment device for changing the throttle cross section. As a result, it is possible to adapt the blade holder, with respect to the effect of the impact absorber, to the respective applications without requiring changes to the blade holder. With slow-running machines, the impact absorber can be adjusted via the adjustment means in such a way that it is uniformly effective in both directions by opening up the throttle cross section.

According to the invention, the return valve can be designed as a tongue-shaped, spring-activated valve or even as a spring-activated ball valve.

For the simplest design, the pressure chamber can be filled with air, so that air is released from the pressure chamber to the surrounding area and is sucked in from the surrounding area. It is advantageous in that case if at least one air filter is assigned to the air-conducting parts of the return valve and/or the throttle to prevent dirt particles in the environment from entering.

According to another embodiment of the invention, the pressure chamber is connected via the throttle as well as the return valve to a collection chamber for the pressure medium. This arrangement has the advantage of a closed system, so that impurities in the environmental air do not influence the operation of the impact absorber. The collection chamber should be designed such that once the return valve opens up, the medium can flow out of the pressure chamber practically without counter pressure or only against a small counter pressure. The design as a closed system also permits using a liquid pressure medium.

The invention is explained in further detail with the aid of schematic drawings of exemplary embodiments. Shown are in:

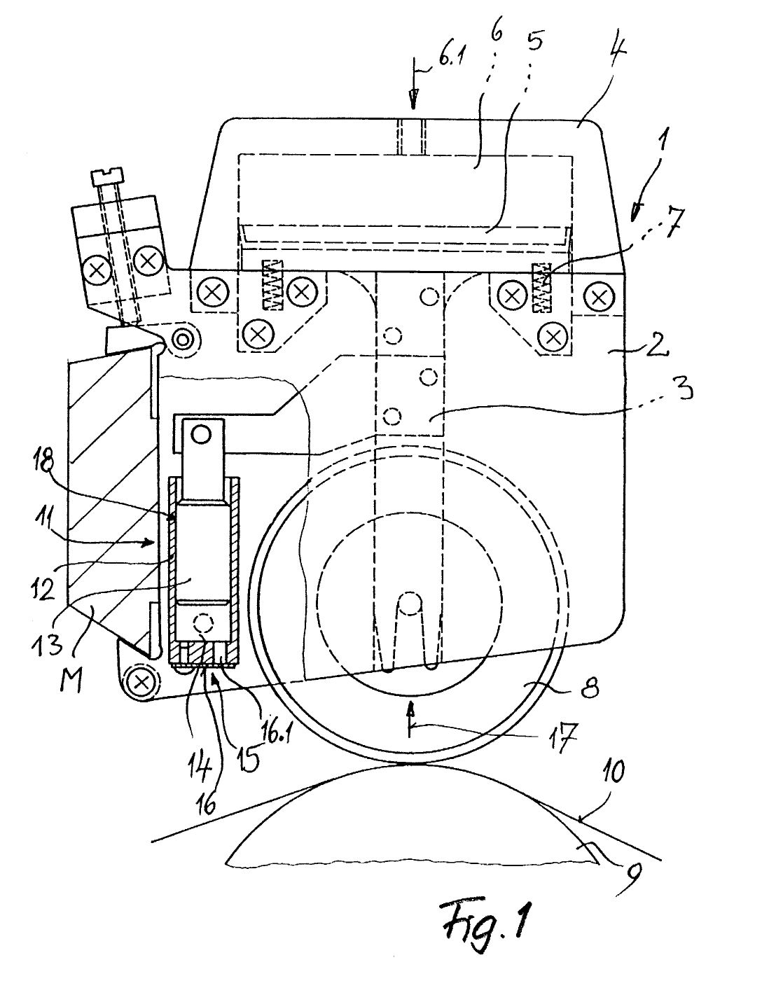

FIG. 1 A crush blade holder with inside impact absorber, seen as a partial sectional view from the side.

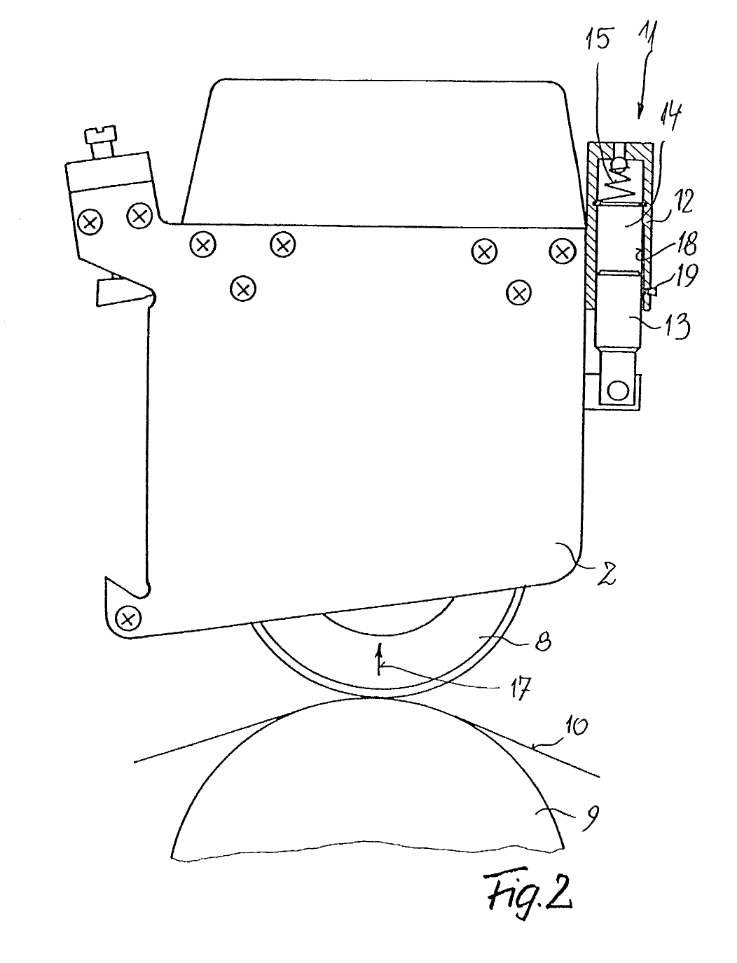

FIG. 2 A different embodiment of a crush blade holder with outside-positioned impact absorber.

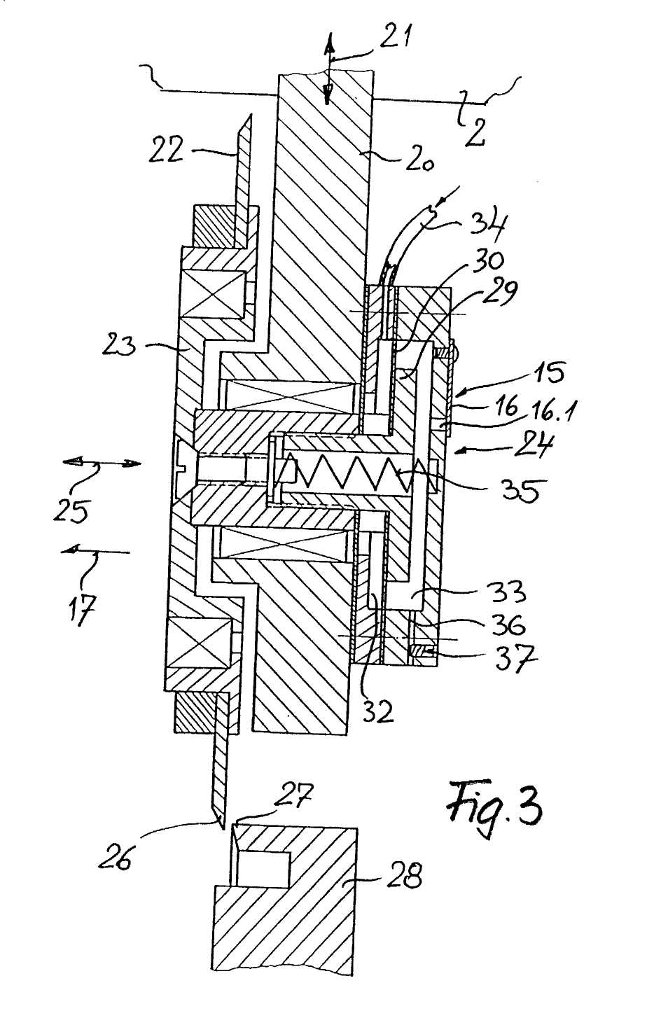

FIG. 3 The blade-carrying portion of a shearing cut blade holder, on an enlarged scale.

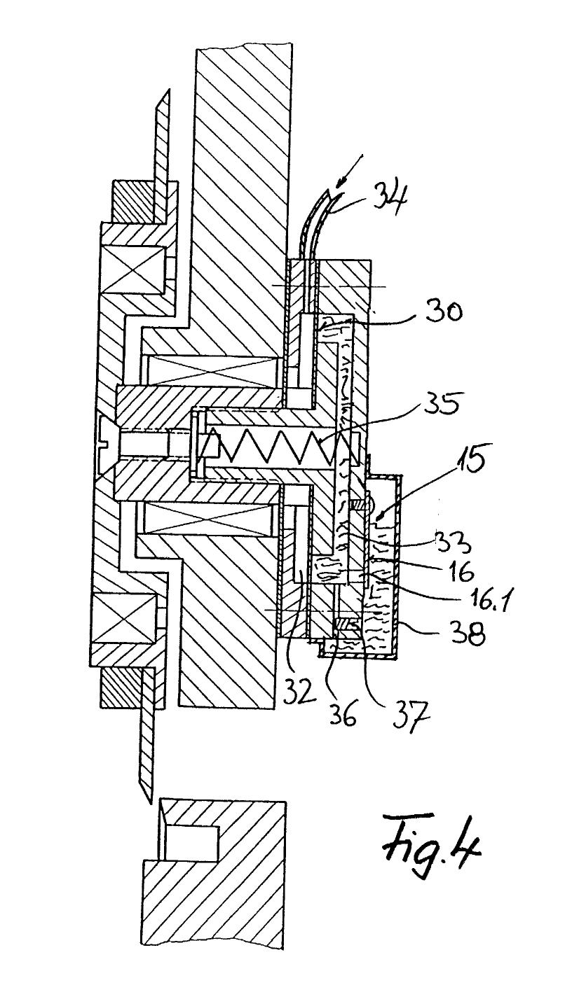

FIG. 4 A modified embodiment of the blade holder according to FIG. 3.

FIG. 1 shows a view from the side of a crush blade holder 1 in the operating position. The crush blade holder is attached with its basic body 2 to a cutter bar M of a device for dividing a material web in longitudinal direction. A blade carrier 3 is positioned displaceable inside the basic body 2 and is connected with its upper end to a pneumatic adjustment drive 4. The adjustment drive 4 is essentially formed by a piston 5 connected to the blade carrier 3, which piston is positioned sealed inside a cylinder 6 and is kept in the idle position with resetting springs 7 if the cylinder 6 is not under pressure. The cylinder 6 can be activated accordingly with compressed air (arrow 6.1).

A circular blade 8 in the form of a crush blade is positioned rotating on the blade carrier 3. In the operating position shown herein, the circular blade is pressed against a counter blade 9 in the form of a roller, so that a continuous material web 10 can be divided accordingly in longitudinal direction. In the operating position shown herein, the cylinder chamber 6 is supplied with compressed air, so that the circular blade 8 is pressed against the counter blade 9. Upon removing pressure from the cylinder 6, the circular blade 8 is lifted off the counter blade 9 and assumes the idle position.

An impact absorber 11 is arranged between the fixed adjustment drive 4 and the circular blade 8, which can be moved with the aid of blade carrier 3. This impact absorber essentially consists of a cylinder 12 that is connected to the basic body 2 and a piston body 13, which is connected to the blade carrier 3 and delimits a pressure chamber 14 inside the cylinder 12.

The cylinder 12 for the exemplary embodiment shown herein is provided with a return valve 15 in the form of a tongue-shaped, spring-activated valve with a large valve bore 16.1, which is closed off by a spring-activated tongue 16.

If the adjustment drive 4 is subjected to compressed air, the blade carrier 3 is advanced toward the counter blade 9 and, in the process, the air is pushed from the compression chamber 14 via the piston 13 and through the valve bore 16.1 of return valve 15. The spring-activated tongue 16 in this case is designed such that only a slight spring force must be overcome.

The return valve 15 remains closed if a true running irregularity, for example a height jump of counter blade 3 or circular blade 8, causes a force to be exerted onto the blade carrier 3 in the direction of arrow 17, meaning counter to the press-on direction of adjustment drive 4.

The exemplary embodiment shown herein is provided with a throttle 18, so that the circular blade 8 can still evade. A defined gap is provided for this between the inside wall of cylinder 12 and the circumferential surface area of the piston body 13, which gap functions a throttle over its cross section and its length. Thus, in addition to the adjustment force exerted by the adjustment drive 4, the flow resistance caused by the throttle opening must be overcome when air is suctioned from the environment into the pressure chamber 14 to allow a movement in the direction of arrow 17. The impact absorber therefore has a high compliance when force is exerted in press-on direction, meaning the direction of the adjustment force, whereas it has a low compliance when force is exerted counter to the press-on direction shown with arrow 17. The circular blade 8 can evade, to be sure, but cannot “pivot through” as a result of the strongly damping influence of the flow-reduction effect. Once this “interfering” force effect is removed, the adjustment force can readjust the circular blade 8, thus practically preventing if from lifting off the counter blade 9.

FIG. 2 also shows a view from the side of a crush blade of the type as described in the above. The crush blade deviates from the above-described blade according to FIG. 1 only in that the impact absorber 11 is not arranged inside the basic body 2, but is mounted on the outside of the basic body 2. For this embodiment, the impact absorber also has a cylinder 12 that is provided with a return valve 15. The piston 13, in turn, is connected via a corresponding extension to the blade carrier 3.

The return valve for the exemplary embodiment shown herein is a spring-activated ball valve, which opens up when the piston 12 [sic] moves in press-on direction against the counter blade 9 and remains closed if a force is effective in the direction of arrow 17, i.e. for a movement of piston 13 in the direction of arrow 17. Air can escape from the compression chamber 14 only via the groove functioning as the throttle. The opening cross section of the throttle can be changed for this embodiment with an adjustment screw 19, so that the throttle effect and thus the flow resistance to be overcome in each case can be adapted to the individual application case.

FIG. 3 shows that portion of the shearing blade holder, which is responsible for the cutting force. A circular blade 22 is positioned in this case on a guide rod 20, such that it can rotate on a blade carrier 23. The guide rod can be moved inside a basic body that is only indicated herein with a drive in arrow direction 21, either upward to the idle position or downward to the working position. With the aid of an adjustment drive 24, the blade carrier 23 can be moved in the direction of arrow 25 from the illustrated idle position to an operating position. The circular blade 22 thus rests with its cutting edge 26 against the cutting edge 27 of a counter blade 28, designed as a grooving blade, such that it covers this blade.

For the exemplary embodiment shown herein, only the axially displaceable and non-rotating blade carrier 23 is connected on its end facing away from the circular blade 22 to a piston body 29, which is provided with a sealing membrane 30. The sealing membrane 30 divides the cylinder 31 into an operating pressure chamber 32 and an impact absorbing pressure chamber 33.

The operating pressure chamber 32 is connected via a feed line 34 to a pressure medium supply. The piston body 29 while under pressure is therefore displaced counter to the force of a resetting spring 35 and the circular blade 22 is pressed against the cutting edge 27 of counter blade 28.

As a result of the movement of piston body 19[sic], air is pushed from the compression chamber 33 since the pressure chamber 33 is provided with a return valve 15 in the form of a tongue-shaped spring-activated valve of the type as described with the aid of FIG. 1.

In the event that a force is exerted during the operation in the direction of arrow 17 while the return valve 15 is closed and the adjustment pressure is still present in the operating compression chamber 32, air can flow back into the compression chamber 33 only via a throttle 18 with throttle opening 36 and by overcoming a corresponding flow resistance.

For this embodiment, the throttle effect can be adjusted with a respective adjustment screw 37 and by changing the flow cross section of the throttle opening 36.

The above-described embodiments all have the advantage that the pressure level in the pressure chamber can always adjust to that of the environmental air via the throttle, even if it occurs with a time delay, provided the circular blade is not subjected to a pulsating force resulting from a true running irregularity or the like. This always ensures a reliable engagement between circular blade and counter blade.

FIG. 4 shows a modified version of the embodiment shown in FIG. 3, for which the throttle opening 36 on the one hand and the through opening 16.1 of the return valve 15 on the other hand empty into a collection chamber 38. For this, the collection chamber 38 can have a large opening toward the environment. A filter body is inserted into this opening, so that in a dust-loaded environment, the air required for operating the impact absorber is pushed into the collection chamber 38 and can flow from this collection chamber 38 back into the compression chamber 33. Means for filtering dust can be assigned in the same way to the return valve 15 and the throttle 18 of the other embodiments.

The use of such a collection chamber also makes it possible to use a liquid medium in place of air for the impact absorber. With the exemplary embodiment shown herein, the pressure chamber 33 is sealed tightly against the operating pressure chamber 32 with the aid of membrane 30, thus practically preventing any leakage losses. The collection chamber 38 herein is shown only schematically with respect to its function, so that a different, space-saving configuration is possible as well.

Given a respective design, for example the use of a seal between piston and cylinder, impact absorbers of the type described with the aid of FIGS. 1 and 2 can also be converted for use with a liquid pressure medium in connection with a collection chamber.

The throttle 18 can furthermore be designed as spring-activated return valve, wherein the spring force must be strong enough to effect a delay of the movements in the direction of arrow 17. The piston-cylinder unit in that case acts as a spring for certain stroke regions.

1. A blade holder for a device for dividing a material web (10) in longitudinal direction, said blade holder comprising a basic body (2) that can be secured on a cutter bar (M) of the device, further comprising a blade carrier (3; 23) that can be moved relative to the basic body (2), on which a circular blade (8; 22) is positioned rotating and which is connected to an adjustment drive (4; 24) for moving the circular blade (8; 22) from an idle position to an operating position where it is pressed against a coordinated rotating counter blade (9; 28) of the device, as well as comprising an impact absorber (11) that is effective between the adjustment drive (4; 24) and the circular blade (8; 22) and has a high compliance for a force effective in press-on direction and a low compliance for a force effective counter to the press-on direction.

2. A blade holder according to claim 1, characterized in that the impact absorber (11) is formed by a cylinder (12) and a piston body (13) that can be moved relative to the cylinder and partitions off a pressure chamber (14) inside the cylinder and that a throttle (18) and a return valve (15) are assigned to the pressure chamber (14; 33), wherein the return valve (15) opens up in press-on direction during a movement of circular blade (8).

3. A blade holder according to claims 1 and 2, characterized in that the gap between the piston (13) and the cylinder wall functions as a throttle.

4. A blade holder according to one of the claims 1 to 3, characterized in that the throttle (18; 36) is provided with an adjustment means (19; 37) for changing the cross section of the throttle.

5. A blade holder according to one of the claims 1 to 4, characterized in that the return valve (15) is designed as tongue-shaped, spring-activated valve.

6. A blade holder according to one of the claims 1 to 4, characterized in that the return valve (15) is designed as spring-activated ball valve.

7. A blade holder according to one of the claims 1 to 6, characterized in that the pressure chamber (14; 33) contains air.

8. A blade holder according to one of the claims 1 to 7, characterized in that a particle filter is assigned to the throttle (18; 36) and/or the return valve (15).

9. A blade holder according to one of the claims 1 to 7, characterized in that the pressure chamber (33) is connected to a collection chamber (38) for the pressure medium via the throttle (36) on the one hand and the return valve (15) on the other hand.
